(19) United States
(12) Patent Application Publication
(10) Pub. No.: US 2013/0335643 A1
(43) Pub. Date: Dec. 19, 2013

(54) PROJECTION-TYPE IMAGE DISPLAY DEVICE AND LIGHT QUANTITY ADJUSTMENT METHOD

(71) Applicants: Kenji Ishida, Tokyo (JP); Kazuya Fukuda, Tokyo (JP)

(72) Inventors: Kenji Ishida, Tokyo (JP); Kazuya Fukuda, Tokyo (JP)

(21) Appl. No.: 14/002,097

(22) PCT Filed: Mar. 4, 2011
(86) PCT No.: PCT/JP11/55041

§ 371 Date: Aug. 28, 2013

(51) Int. Cl. H04N 5/74

(52) U.S. Cl. CPC H04N 5/7408
USPC 348/744

(57) ABSTRACT

A projection-type image display device includes: a light source; a display element that displays an image based on an input video signal; a trapezoidal distortion correction unit that performs pixel conversion in which pixel data of the input video signal are compressed or interpolated and supplies the display element with the corrected signal that includes a first video signal that is the video signal concerning which the pixel conversion has been carried out; a detection unit that detects the luminance distribution of the first video signal; and an adjustment unit that adjusts the light quantity of the light source based on the detected luminance distribution data.

### TECHNICAL FIELD

The present invention relates to a projection-type image display device that adjusts the light quantity of a light source according to the luminance distribution of input video signals.

### BACKGROUND ART

A liquid crystal projector is proposed in which the luminance distribution of images based on input video signals is detected and the light quantity of a lamp is adjusted based on the detected luminance distribution (see Patent Document 1).

The liquid crystal projector disclosed in Patent Document 1 includes, for example, an input signal processor, a luminance distribution detection unit, a signal correction unit, a synthesizing unit, a drive unit, a display panel, a CPU (Central Processing Unit), a UI (User Interface) control unit, an iris control unit, and an iris device.

The input signal processor converts the input signal to a predetermined signal form (RGB signal). The luminance distribution detection unit detects the luminance distribution state of the output signal of the input signal processor, judges whether the image that is based on the input signal is a bright image or dark image based on this detected luminance distribution state, and supplies the result to the CPU.

The signal correction unit receives the output signal of the input signal processor by way of the luminance distribution detection unit and subjects this received signal to adjustment such as gamma correction or sharpness adjustment.

The synthesizing unit supplies a signal output from the signal correction unit to the drive unit. When display image data for the UI is supplied from a UI control unit to the synthesizing unit, the synthesizing unit supplies the drive unit with a signal realized by combining the display image data for the UI and the signal output from the signal correction unit.

The drive unit drives the display panel based on the signal that is supplied from the synthesizing unit. The iris device adjusts the quantity of light that is irradiated upon the display panel. The iris control unit controls the iris device in accordance with control signals from the CPU.

The CPU supplies the iris control unit with a control signal indicating that the iris aperture is to be increased when it receives a judgment result from the luminance distribution detection unit that indicates a bright image, and supplies the iris control unit with a control signal indicating that the iris aperture is to be decreased when it receives a judgment result from the luminance distribution detection unit that indicates a dark image.

According to the liquid crystal projector disclosed in Patent Document 1, display of a dark image is brought about by reducing the aperture of the iris device when the image is dark, and display of a bright image is brought about by increasing the aperture of the iris device when the image is bright, whereby the contrast sense is improved.

However, while the display element of the projector has a fixed resolution, various resolutions exist for input signals. A resolution conversion technology is used to display this variety of input signals. Resolution conversion refers to a technology of compressing and expanding images such that input signals of various resolutions match the resolution of a display element such as a liquid crystal display.

When a projector is placed so as to be inclined with respect to the screen, the projected image on the screen is deformed to a trapezoid. As a technology for revising this deformed projection image to a rectangle, there is the so-called trapezoid distortion correction technology that is an electrical correction technology for altering the range of the effective pixel area on a display panel (see Patent Document 2).

In resolution conversion, the compression rate or expansion rate of an image is uniform over the entire screen, but in trapezoidal distortion correction technology, the compression rate and expansion rate differ according to the position of the row or column of the image. These technologies require frame memory for processing, and resolution conversion and trapezoidal distortion correction are therefore typically provided in the same LSI.

In trapezoidal distortion correction, a reversed trapezoidal effective pixel area is formed on the display panel by compressing pixels or interpolating pixels such that the projected image becomes a rectangular image. Areas other than the effective pixel area are displayed as black (display of the lowest luminance level of the tonal range).

The video signal that follows the trapezoidal distortion correction is a signal obtained by adding a signal of black display areas to the signal of the effective pixel area. A rectangular projected image can be obtained by projecting the image that is displayed in the reverse trapezoidal effective pixel area onto a screen.

Although the existence or absence of a resolution conversion circuit and trapezoidal distortion correction circuit that carries out trapezoidal distortion correction is not clear in the liquid crystal projector described in Patent Document 1, it is considered typical for a resolution conversion circuit and trapezoidal distortion correction circuit to be included in a synthesizing unit for the purpose of making the size of OSD characters, that are combined with input signals of various resolutions, equal when combining OSD signals from a UI control unit with signals of fixed resolution that follow resolution conversion.

### LITERATURE OF THE PRIOR ART

### Patent Documents

### Patent Document 1: Japanese Unexamined Patent Application Publication No. 2008-046572

### Patent Document 2: Japanese Unexamined Patent Application Publication No. 2000-347290

### DISCLOSURE OF THE INVENTION

When a trapezoidal distortion correction circuit such as disclosed in Patent Document 2 is provided in the synthesizing unit in the liquid crystal projector disclosed in Patent Document 1, the luminance distribution detection unit detects the luminance distribution of a video signal before resolution conversion and trapezoidal distortion correction, and the display panel displays an image based on the video signal that follows resolution conversion and trapezoidal distortion correction. As a result, the problem arises that luminance distribution detection units must be made to individually correspond to input signals of various resolutions, which results in a more complex circuit structure.

When the luminance distribution detection unit is provided in a stage that follows the trapezoidal distortion correction circuit, the following problem arises.

FIG. 1 shows positions of the start and end of data acceptance of a video signal during detection of luminance distribution by a luminance distribution detection unit. In FIG. 1, the pulse signal that is shown on the upper side of the figure is a horizontal synchronizing signal, and the pulse signal shown on the left side is a vertical synchronizing signal.

The horizontal synchronizing signal contains horizontal effective intervals and horizontal blank intervals, the horizontal blank intervals being prescribed by the timings of the rise and fall of the pulse. The vertical synchronizing signal contains vertical effective intervals and vertical blank intervals, the vertical blank intervals being prescribed by the timings of the rise and fall of the pulse.

The effective picture area is the area in which luminance distribution is detected and is prescribed by the horizontal effective intervals of the horizontal synchronizing signal and the vertical effective intervals of the vertical synchronizing signal. The coordinate indicated by the black point on the upper left of the effective picture area is the starting coordinate (xs, ys), and the coordinate indicated by the black point on the lower right of the effective picture area is the ending coordinates (xe, ye). The starting coordinate (xs, ys) and ending coordinate (xe, ye) are set in advance.

The luminance distribution detection unit sequentially takes in data from the pixel that corresponds to the starting coordinate (xs, ys) of the video signal to the pixel that corresponds to the ending coordinate (xe, ye) (signal level sampling). The luminance distribution detection unit then obtains luminance distribution data of the video signal based on the luminance values of each of the received pixel data.

In trapezoidal distortion correction, processing is carried out to form an effective pixel area of reverse trapezoidal shape on the display panel by implementing pixel conversion that compresses pixels or interpolates pixels and to make areas, other than this effective pixel area, become black display areas. As a result, the video signal that follows trapezoidal distortion correction includes a signal of the effective pixel area and a signal of the black display area.

FIG. 2A shows an example of an image that is displayed on a display panel based on a video signal that has been subjected to trapezoidal distortion correction (horizontal trapezoidal distortion correction) for the horizontal direction.

The display image that is based on a video signal that follows horizontal trapezoidal distortion correction includes effective pixel area 711 of reverse trapezoidal shape in which an image is displayed based on the video signal that follows the pixel conversion process and black image display areas 712 that are located above and below effective pixel area 711.

When detecting the luminance distribution of a video signal that follows horizontal trapezoidal distortion correction, the luminance distribution detection unit takes in pixel data of each of effective pixel area 711 and black areas 712 with the coordinate of the upper left pixel of the display image as starting coordinate (xs, ys) and the coordinate of the lower right pixel as the ending coordinate (xe, ye). The luminance distribution detection unit then acquires the luminance distribution of the video signal based on the luminance of each item of the pixel data that were received. The luminance distribution that is acquired in this way includes not only luminance data of effective pixel area 711 but also luminance data of black image display areas 712 and may therefore differ greatly from the luminance distribution of the projected image (corresponding to the luminance distribution of effective pixel area 711).

FIG. 2B shows an example of an image that is displayed on a display panel based on a video signal that has been subjected to trapezoidal distortion correction (vertical trapezoidal distortion correction) for the vertical direction.

The display image that is based on the video signal that follows vertical trapezoidal distortion correction includes effective pixel area 721 of a reverse trapezoidal shape in which an image is displayed based on the video signal that follows the pixel conversion process and black image display areas 722 that are located to the left and right of effective pixel area 721. In this case as well, the luminance distribution detection unit takes in pixel data of each of effective pixel area 721 and black image display areas 722 with the coordinate of the upper left pixel of the display image as the starting coordinate (xs, ys) and the coordinate of the lower right pixel as the ending coordinate (xe, ye), and the luminance distribution that is acquired in luminance distribution detection unit therefore includes the luminance component of effective pixel area 721 and black image display areas 712. As a result, the luminance distribution acquired in luminance distribution detection unit may differ greatly from the luminance distribution of the projected image (corresponding to the luminance distribution of effective pixel area 721).

As described hereinabove, when the luminance distribution detection unit is provided in a stage that follows the trapezoidal distortion correction circuit, the problem arises that the luminance distribution of the video signal that contributes to projection cannot be accurately detected.

It is an object of the present invention to provide a projection-type image display device and light quantity adjustment method that can solve the problem of cases in which a luminance distribution detection unit is provided in a stage that follows the trapezoidal distortion correction circuit and thus allows appropriate adjustment of the light quantity of the light source according to the brightness of the display image to provide superior contrast.

To achieve the above-desrived object, the projection-type image display device of the present invention is a projection-type image display device that includes a light source and a display element that displays an image by spatially modulating light from the light source based on an input video signal and that projects a display image that is displayed on the display element onto a projection screen; and includes:

a trapezoidal distortion correction unit that carries out pixel conversion, in which pixel data of the input video signal are compressed or interpolated, and that supplies the display element with a corrected signal that contains a first video signal that is a video signal concerning which the pixel conversion has been carried out;

a detection unit that detects, of the corrected signal that is supplied as output from the trapezoidal distortion correction unit, the luminance distribution of the first video signal; and

an adjustment unit that receives the luminance distribution data from the detection unit and adjusts the light quantity of the light source based on the received data.

The light quantity adjustment method of the present invention is a light quantity adjustment method that is carried out in a projection-type image display device that includes a light source and a display element that displays an image by spatially modulating light from the light source based on an input video signal and that projects a display image that is displayed on the display element onto a projection screen, and includes:

carrying out pixel conversion that compresses or interpolates pixel data of the input video signal and supplying a corrected signal that includes a video signal, concerning which the pixel conversion has been carried out, to the display element; and

detecting the luminance distribution of the video signal, concerning which the pixel conversion has been carried out, of the corrected signal and adjusting the light quantity of the light source based on the luminance distribution data that were detected.

### BRIEF DESCRIPTION OF THE DRAWINGS

FIG. 1 is a schematic view that shows the starting and ending positions of the data acquisition of a video signal when detecting luminance distribution.

FIG. 2A is a schematic view showing an example of an image that is displayed on a display panel based on a video signal that has undergone trapezoidal distortion correction for the horizontal direction.

FIG. 2B is a schematic view showing an example of an image that is displayed on a display panel based on a video signal that has undergone trapezoidal distortion correction for the vertical direction.

FIG. 3 is a block diagram showing the configuration of the projector of the first exemplary embodiment of the present invention.

FIG. 4 is a schematic view showing the configuration of the optics unit of the projector shown in FIG. 3.

FIG. 5 is a schematic view showing the coordinates of four pointers on an LCD set for a video signal that follows horizontal trapezoidal distortion correction.

FIG. 6 is a schematic view showing the coordinates of four pointers on an LCD set for a video signal that follows vertical trapezoidal distortion correction.

FIG. 7 is a schematic view that shows the coordinates of four pointers on an LCD set for a video signal that follows horizontal/vertical trapezoidal distortion correction.

FIG. 8 is a schematic view showing other coordinates of four pointers on an LCD set for a video signal that follows horizontal/vertical trapezoidal distortion correction.

FIG. 9 is a block diagram showing an example of the iris control unit of the projector shown in FIG. 3.

FIG. 10 is a view for describing luminance distribution data.

FIG. 11 is a block diagram showing the configuration of the projection-type image display device of the second exemplary embodiment of the present invention.

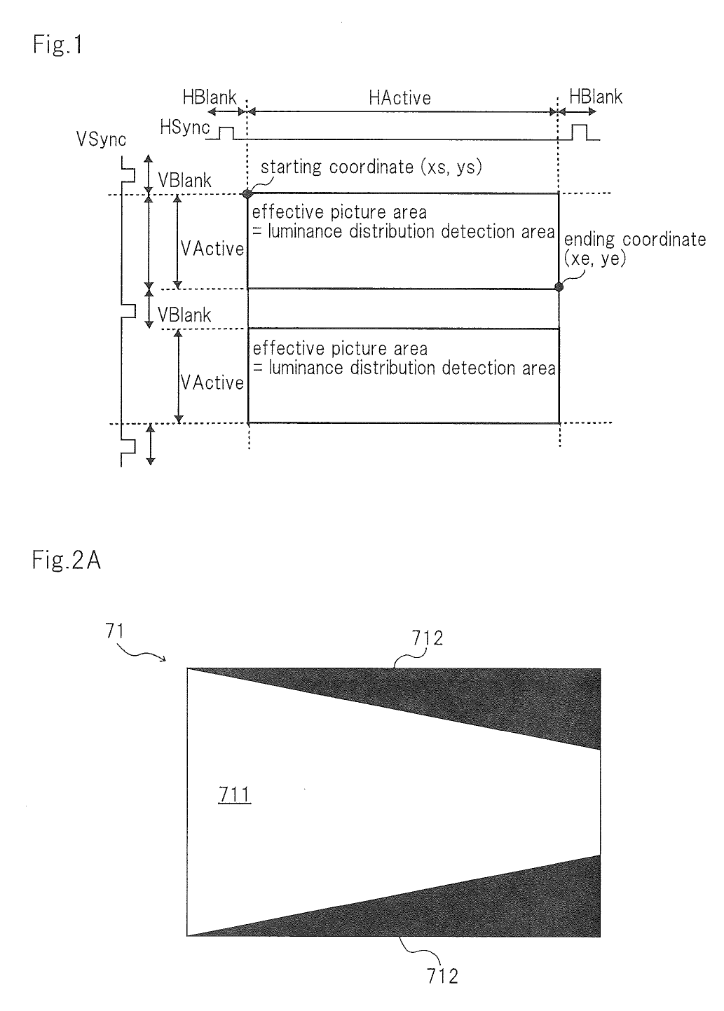

### EXPLANATION OF REFERENCE NUMBERS

1 light source

2 display element

3 trapezoidal distortion correction unit

4 detection unit

5 adjustment unit

### BEST MODE FOR CARRYING OUT THE INVENTION

Exemplary embodiments of the present invention are next described with reference to the accompanying drawings.

### First Exemplary Embodiment

FIG. 3 is a block diagram showing the configuration of the projector of the first exemplary embodiment of the present invention.

Referring to FIG. 3, the projector includes: image input unit 10, scale unit 20, detection unit 30, LCD drive unit 40, optics unit 50, CPU 60, serial bus 601, parallel bus 602, key input unit 603, and remote controller 604.

Image input unit 10, scale unit 20, detection unit 30, optics unit 50, and CPU 60 are connected to serial bus 601 or parallel bus 602. CPU 60 receives operation instructions from key input unit 603 or remote controller 604 and controls the operation of the entire device that includes image input unit 10, scale unit 20, detection unit 30, and optics unit 50.

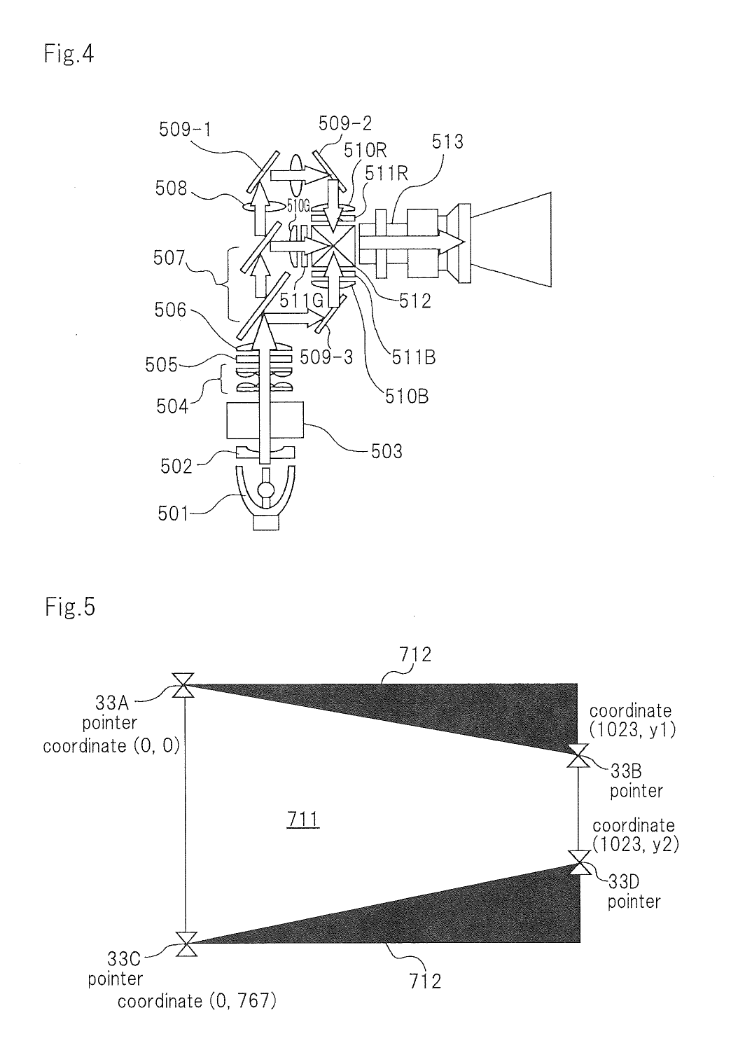

Optics unit 50 is equipped with the capability to implement iris control in accordance with control signals from CPU 60. FIG. 4 shows the configuration of optics unit 50.

As shown in FIG. 4, optics unit 50 includes: lamp 501; cover glass 502; iris control unit 503; integrator 504; flat PBS 505; field lens 507; dichroic mirrors 507; relay lens 508; mirrors 509_1-509_3; condensing lenses 510R, 510G, and 510B; LCDs 511R, 511G, and 511B; cross prism 512; and projection lens 513.

Lamp 501 is a high-pressure mercury lamp but is not limited to this form. For example, a solid-state light source of which an LED is representative can be used as lamp 501.

Light (white light) from lamp 501 passes throught cover glass 502. Iris control unit 503, integrator 504, flat PBS 505, and field lens 507 are arranged in that order in the direction of advance of light that is emitted from lamp 501.

Iris control unit 503 adjusts the light quantity of lamp 501 in accordance with a control signal from CPU 60. Integrator 504, flat PBS 505, and field lens 507 are generally known components and explanation is therefore here omitted.

Parallel luminous flux (white light) of a predetermined polarization component that has passed through field lens 507 is separated into luminous flux of each of the colors of red, green, and blue in dichroic mirrors 507.

The red luminous flux is irradiated upon LCD 511R by way of relay lens 508, mirrors 509_1 and 509_2, and condensing lens 510R. The green luminous flux is irradiated upon LCD 511G by way of condensing lens 510G. The blue luminous flux is irradiated upon LCD 511B by way of mirror 509_3 and condensing lens 510B.

Cross prism 512 color-combines the red image light from LCD 511R, the green image light from LCD 511G, and the blue image light from LCD 511B. Projection lens 513 projects the image light of each of the colors red, green, and blue from cross prism 512 upon a projection screen.

Again referring to FIG. 3, each construction is next described. LCDs 511R, 511G, and 511B are basically of the same construction, and in the following explanation, these constructions are described as LED 511.

Image input unit 10 receives a video signal from an external image supply device and supplies the received video signal to scale unit 20. The external image supply device is, for example, a device such as a personal computer that is capable of supplying a video signal.

Scale unit 20 includes resolution conversion unit 202, OSD (On-Screen Display) display processor 203, and trapezoidal distortion correction unit 204.

Resolution conversion unit 202 carries out a resolution conversion process for matching the resolution of the video signal that is supplied from image input unit 10 to the resolution of LCD 511.

OSD display processor 203 is provided in a stage that follows resolution conversion unit 202. OSD display processor 203 both supplies the output signal of resolution conversion unit 202 to trapezoidal distortion correction unit 204 and, upon receiving an OSD control signal from CPU 60 by way of parallel bus 602, adds the OSD image signal to the output signal of resolution conversion unit 202 in accordance with the OSD control signal. An OSD screen that is based on an OSD image signal is thus displayed on the projection screen. The OSD screen includes menu screens relating to various setting items by which information necessary for extracting the luminance distribution is set.

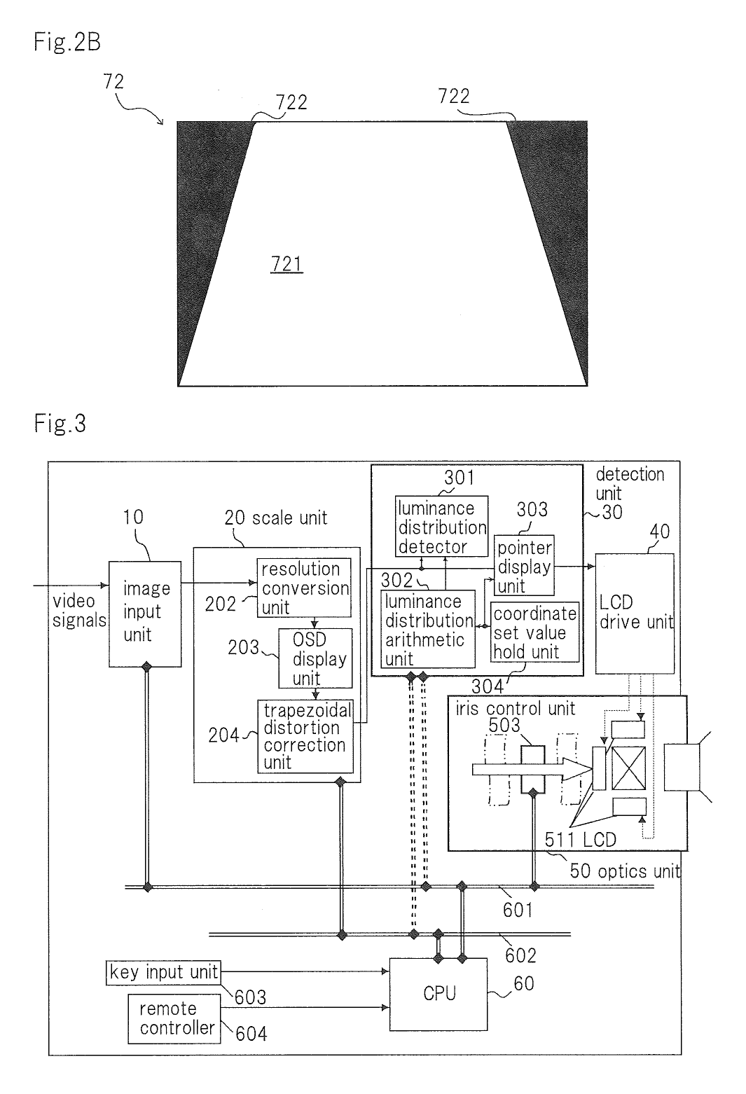

Trapezoidal distortion correction unit 204 carries out trapezoidal distortion correction for the output signal of OSD display processor 203. In trapezoidal distortion correction, a trapezoidal effective pixel area is formed on LCD 511 by compressing pixels or interpolating pixels such that the projected image becomes a rectangular image. Areas other than the effective pixel area are then displayed as black (display of the lowest luminance level of the tonal range). An image is thus displayed only in the trapezoidal effective pixel area on LCD 511 as shown in FIGS. 2A and 2B.

The output signal of trapezoidal distortion correction unit 204 is supplied to detection unit 30. The video signal that follows trapezoidal distortion correction and that is supplied from trapezoidal distortion correction unit 204 includes the video signal of the trapezoidal effective pixel area and the video signal of the black image display areas.

Information necessary for trapezoidal distortion correction (such as the projection distance, projected angle with respect to the projection screen, power of the projection lens) is set by a user using key input unit 603 or remote controller 604. This information setting is carried out, for example, by way of an OSD screen. Alternatively, when the projector is placed directly in front of the projection surface, setting of information necessary for trapezoidal distortion correction becomes unnecessary. In such cases, trapezoidal distortion correction unit 204 supplies the output signal of OSD display processor 203 to detection unit 30 without alteration.

Detection unit 30 detects the luminance distribution of the video signal of the trapezoidal effective pixel area from the video signal that follows trapezoidal distortion correction from trapezoidal distortion correction unit 204 (with the exception of the video signal of the black display areas) and supplies the detection result to CPU 60. In order to realize these luminance distribution operations, detection unit 30 includes luminance distribution detector 301, luminance distribution arithmetic unit 302, pointer display processor 303, and coordinate set value hold unit 304.

Luminance distribution detector 301 detects the luminance distribution of the effective picture area based on the horizontal and vertical starting coordinates (xs, ys) and the horizontal and vertical ending coordinates (xe, ye). By setting the horizontal and vertical starting coordinates (xs, ys) and the horizontal and vertical ending coordinates (xe, ye), any rectangular area can be set as the effective picture area.

The method of detecting the luminance distribution is briefly described hereinbelow.

When an RGB video signal is output from image input unit 10, luminance distribution detector 301 acquires a Y (luminance) signal from the video signal that is supplied from trapezoidal distortion correction unit 204. The Y (luminance) signal is given by the following Equation 1.

Y=0.299R+0.587G+0.114B Equation 1

In the interest of simplifying the circuit, the constants of R, G, and B of the above-described equation may be approximated as 0.25, 0.5, and 0.125, respectively.

When a YCbCr (color difference) video signal is output from image input unit 10, luminance distribution detector 301 uses the Y (luminance) signal that is supplied from trapezoidal distortion correction unit 204 without alteration.

Luminance distribution detector 301 next acquires each of the signal levels of each pixel of the Y (luminance) signal within the effective picture area in the video signal in one vertical synchronization interval, and from the acquisition result, counts the number for each signal level in the tonal range by means of a counter circuit.

For example, when finding the luminance distribution of a Y (luminance) signal of an eight-bit video signal, luminance distribution detector 301 has a total of 256 counter circuits from signal level 0 to signal level 255, and these counter circuits each count up each time the corresponding signal level is received as input. Luminance distribution detector 301 is equipped with a register and holds the count result of each counter circuit as the luminance distribution detection result in the register with each vertical synchronization interval.

Pointer display processor 303 receives the video signal from trapezoidal distortion correction unit 204 and supplies the received video signal to LCD drive unit 40. Pointer display processor 303 synthesizes a pointer image signal for displaying four pointers on the projected image with the video signal from trapezoidal distortion correction unit 204 in accordance with a pointer control signal from CPU 60. Pointer display processor 303 supplies the synthesized video signal to LCD drive unit 40.

The user is able to use key input unit 603 or remote controller 604 to set the four pointers at any position on the projection screen. Coordinate set value hold unit 304 holds the coordinates on LCD 511 of the four pointers that are manipulated by the user.

When the four pointers are set at the four corners of the projected image, the coordinates of these pointers on the LCD 511 are the coordinates of the four corners of the trapezoidal effective pixel area. Accordingly, in the display image that is based on the video signal that follows trapezoidal distortion correction, the trapezoidal effective pixel area such as shown in FIGS. 2A and 2B can be specified based on coordinate set value hold unit 304, whereby luminance distribution data of the black image display areas 712 and 722 that are inserted when trapezoidal distortion correction is applied can be excluded.

Based on the coordinate values of each pointer that are held in coordinate set value hold unit 304, luminance distribution arithmetic unit 302 excludes, from luminance distribution data that were detected in luminance distribution detector 301, the luminance distribution data of black image display areas 712 and 722 that are inserted at the time of applying trapezoidal distortion correction and finds the luminance distribution data of only the trapezoidal effective pixel area. In this way, the optimum luminance distribution (or histogram) data for an image that is actually projected can be found for an input video signal even in a state in which an OSD screen is superposed or a state in which trapezoidal distortion correction is applied.

CPU 60 both acquires the optimum luminance distribution (or histogram) data from luminance distribution arithmetic unit 302 by way of serial bus 601 or parallel bus 602 and supplies iris control unit 503 with a control signal for light quantity adjustment based on this acquired luminance distribution data.

The actual operations of the projector of the present exemplary embodiment are next described.

The actual operations of pointer setting and pointer coordinate holding by detection unit 30 are first described.

When the user carries out predetermined operations by key input unit 603 or remote controller 604, OSD display processor 203 adds an OSD image signal to the output signal of resolution conversion unit 202 in accordance with the OSD control signal from CPU 60, whereby an OSD screen (menu screen) is displayed on the projection screen.

Next, when the user alters the coordinates by button operations (or input of numerical values) on the menu screen via key input unit 603 or remote controller 604, CPU 60, in concert with these operations, causes holding of the values of each of the coordinates (xa, ya), (xb, yb), (xc, yc), and (xd, yd) of pointers A-D in coordinate set value hold unit 304 by way of CPU system serial bus 601 or CPU system parallel bus 602.

Each of the coordinate set values that are held in coordinate set value hold unit 304 are communicated to luminance distribution arithmetic unit 302 and pointer display unit 303. Pointer display processor 303 changes the display positions of pointers A-D. Based on each of the coordinate set values of pointers A-D that were set, luminance distribution arithmetic unit 302 generates enable signals for activating or halting the counter circuits in luminance distribution detector 301. These enable signals are synchronized with the input video signal and turn OFF the enable signals to halt the counter circuits in luminance distribution detector 301 when the input video signal enters the coordinates of black image display areas 712 and 722.

Luminance distribution detector 301 activates or halts the counter circuits for each signal level of each pixel of the Y (luminance) signal by means of enable signals that are generated in luminance distribution arithmetic unit 302.

The operation of acquiring optimum luminance distribution data by detection unit 30 is next described.

FIG. 5 shows the coordinate values of pointers A-D on LCD 511 that are set for a video signal that follows horizontal trapezoidal distortion correction. In this example, pointer 33A is set to coordinate (0, 0), pointer 33B is set to coordinate (1023, y1), pointer 33C is set to coordinate (0, 767), and pointer 33D is set to coordinate (1023, y2). The partitioning of effective pixel area 711 and black image display area 712 can be carried out based on each of the coordinate values of these pointers 33A-33D.

Luminance distribution arithmetic unit 302 finds the luminance distribution for effective pixel area 711 by excluding upper and lower black image display areas 712 that are found by the following equations from the luminance distribution data of the rectangular area that was found by luminance distribution detector 301.

black image display area (upper)={1024×(y1+1)}/2

black image display area (lower)={1024×(768−y2)}/2 Equations 2

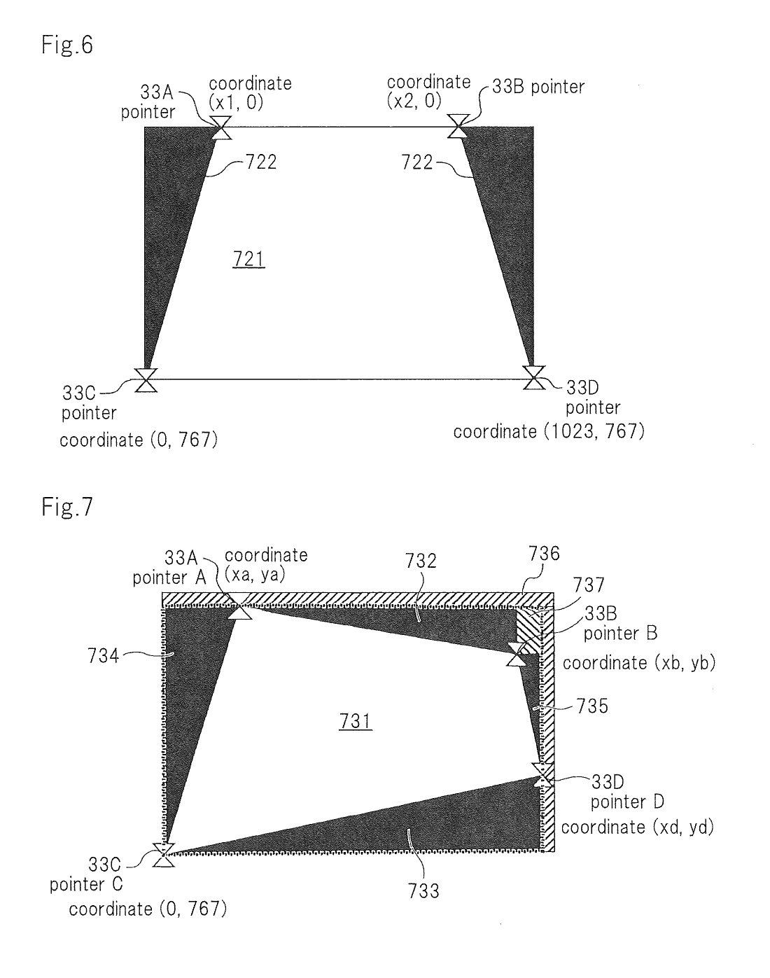

FIG. 6 shows the coordinate values of each of pointers A-D on LCD 511 that were set for the video signal that follows vertical trapezoidal distortion correction. In this example, pointer 33A is set to coordinate (x1, 0), pointer 33B is set to coordinate (x2, 0), pointer 33C is set to coordinate (0, 767), and pointer 33D is set to coordinate (1023, 767). The partitioning of effective pixel area 721 and black image display area 722 can be carried out based on each of the coordinate values of these pointers 33A-33D.

Luminance distribution arithmetic unit 302 excludes left and right black image display areas 722 that are found by the following equations from the luminance distribution data of the rectangular area that was found by luminance distribution detector 301 to find the luminance distribution for effective pixel area 721.

black image display area (left)={(x+1)×768}/2

black image display area (right)={(1024−x2)×768}/2 Equations 3

FIG. 7 shows an example of the coordinate values of pointers A-D on LCD 511 that are set for the video signal that follows horizontal/vertical trapezoidal distortion correction. In this example, pointer 33A is set to coordinate (xa, ya), pointer 33B is set to coordinate (xb, yb), pointer 33C is set to coordinate (0, 767), and pointer 33D is set to coordinate (xd, yd). The partitioning of effective pixel area 731 and black image display areas 732-735 and 737 can be carried out based on each of the coordinate values of these pointers 33A-33D. Area 736 is an area not detected in luminance distribution detector 301.

In the case described above, the range designation of the rectangular area that is detected in luminance distribution detector 301 is first changed to:

starting coordinate (0, 0)→(0, ya)

ending coordinate (10223, 767)→(xd, 767)

Upper, lower, left, and right black image display areas 732-735 are specified by the following equations:

black image display area (upper)={(xb−xa+1)×(yb−ya+1)}/2

black image display area (lower)={(xd+1)×(768−yd)}/2

black image display area (left)={(xa+1)×(768−ya)}/2

black image display area (right)={(xd−xb+1)×(yd−yb+1)}/2 Equations 4

The upper right black image display area 737 is specified by the following equation:

black image display area (upper right)={(xd−xb+1)×(yb−ya+1)} Equation 5

Luminance distribution arithmetic unit 302 then finds the luminance distribution for effective pixel area 731 by excluding black image display areas 732-735 and 737 that were specified above from the luminance distribution data of the rectangular area that was found by luminance distribution detector 301.

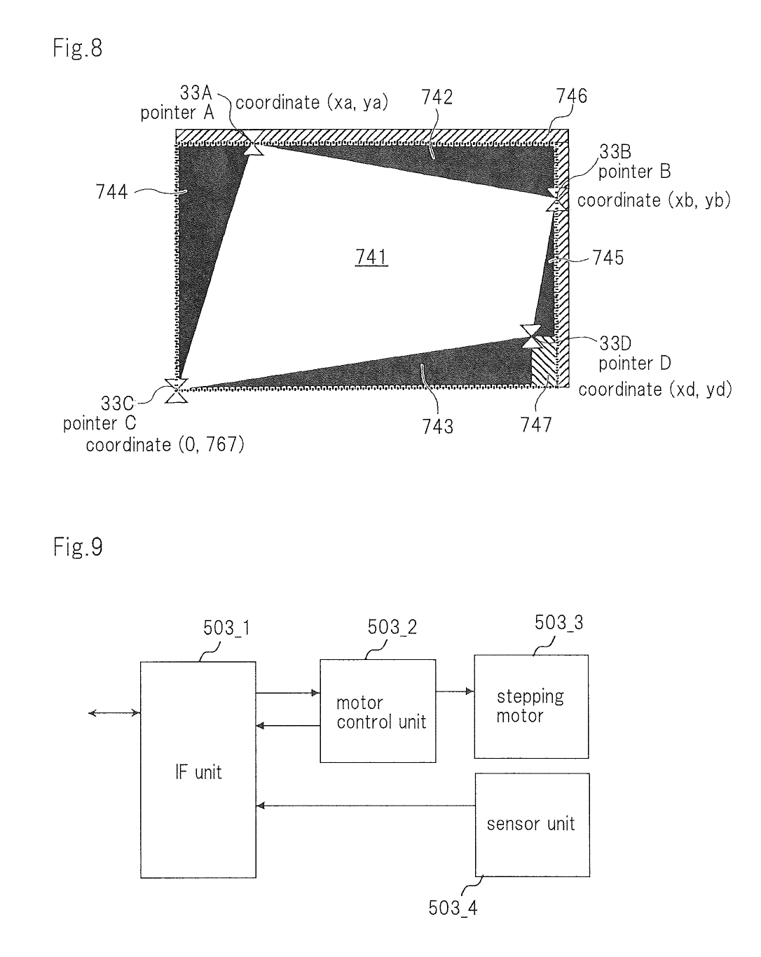

FIG. 8 shows an example of other coordinate values of pointers A-D on LCD 511 that are set for the video signal that follows horizontal/vertical trapezoidal distortion correction. In this example, pointer 33A is set to coordinate (xa, ya), pointer 33B is set to coordinate (xb, yb), pointer 33C is set to coordinate (0, 767), and pointer 33D is set to coordinate (xd, yd). Pointer 33D is positioned to the left of pointer 33B. The partitioning of effective pixel area 741 and black image display areas 742-745 and 747 can be carried out based on each of the coordinate values of these pointers 33A-33D. Area 746 is an area that is not detected by luminance distribution detector 301.

In the case described above, the range designation of the rectangular area detected by luminance distribution detector 301 is first changed, similar to the example shown in FIG. 7.

The upper, lower, left, and right black image display areas 742-745 are specified by the following equations.

black image display area (upper)={(xb−xa+1)×(yb−ya+1)}/2

black image display area (lower)={(xd+1)×(768−yd)}/2

black image display area (left)={(xa+1)×(768−ya)}/2

black image display area (right)={(xb−xd+1)×(yd−yb)}/2 Equations 6

Lower right black image display area 747 is further specified by the following equation.

black image display area (lower right)={(xb−xd+1)×(768−yd)} Equation 7

Luminance distribution arithmetic unit 302 finds the luminance distribution for effective pixel area 731 by excluding the above-described designated black image display areas 742-745 and 747 from the luminance distribution data of the rectangular area that was found by luminance distribution detector 301.

In the above explanation, luminance distribution arithmetic unit 302 specifies the black image display areas, but this specification process may also be carried out in a software process realized by CPU 60.

After the above-described detection of the luminance distribution, iris control unit 503 adjusts the light quantity of lamp 501 based on the luminance distribution (or histogram) data that were acquired in luminance distribution arithmetic unit 302 in accordance with a control signal from CPU 60.

The actual operations of the light quantity adjustment of iris control unit 503 are described hereinbelow.

FIG. 9 shows an example of iris control unit 503.

As shown in FIG. 9, iris control unit 503 is a component having the mechanism of an iris in which the size of an aperture is variable and includes: IF unit 503_1, motor control unit 503_2, stepping motor 503_3, and sensor unit 503_4. The opening and closing operations of the iris are implemented by stepping motor 503_3.

IF unit 503_1 is connected to serial bus 601. Motor control unit 503_2 receives information of the rotation direction, the number of rotation steps, and the rotational speed of the motor from CPU 60 by way of IF unit 503_1, and based on the received information, controls stepping motor 503_3. Sensor unit 503_4 detects the reference position of the gears and rotation position of stepping motor 503_3 and monitors the stop position of the iris.

CPU 60 reads the value of the luminance distribution that is counted by luminance distribution detector 301 for each fixed interval (for example, one vertical synchronization interval).

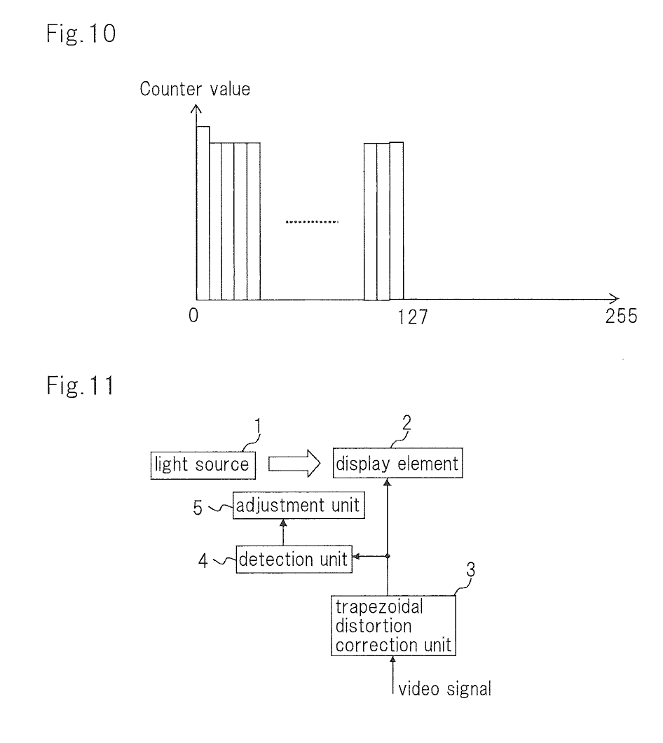

FIG. 10 shows an example of the luminance distribution data. In this example, the signal levels of the luminance distribution of the Y (luminance) signal are all less than 127. In the case of this luminance distribution data, CPU 60 controls the operation of light quantity adjustment by iris control unit 503 such that the light quantity of lamp 501 falls to one half.

In LCD drive unit 40, the image input level may be set to double to make the Y (luminance) level of the screen, that is projected, uniform.

When the signal level of the luminance distribution of the Y (luminance) signal surpasses 128, CPU 60 controls the light quantity adjustment operation by iris control unit 503 such that the light quantity of lamp 501 returns to its original value.

According to the projector of the present exemplary embodiment described hereinabove, when the user uses key input unit 603 or remote controller 604 to carry out a predetermined input operation, CPU 60 transmits an image signal for displaying an OSD screen to the OSD display processor, whereby an OSD screen is displayed on a projection screen.

When the user uses key input unit 603 or remote controller 604 to select a setting item of information that is necessary for luminance distribution detection on an OSD screen and carries out predetermined input operations, pointer display processor 303 displays the operation screen of four pointers A-D on the projection screen.

Next, when the user uses key input unit 603 or remote controller 604 to set the coordinates of pointers A-D by button operation (or number value input) on a menu screen, CPU 60 operates in concert to hold the values of each of the coordinates of pointers A-D in coordinate set value hold unit 304.

Luminance distribution arithmetic unit 302 next, based on the coordinate values of each pointer that are held in coordinate set value hold unit 304, excludes the luminance distribution data of the black image display areas from the luminance distribution data that were detected by luminance distribution detector 301 and finds the luminance distribution data of only the trapezoidal effective pixel area.

Finally, CPU 60 acquires the optimum luminance distribution data from luminance distribution arithmetic unit 302, and based on this luminance distribution data that was acquired, supplies a control signal for light quantity adjustment to iris control unit 503.

By means of the above described operations, the luminance distribution of a video signal that was detected and that follows trapezoidal distortion correction in luminance distribution arithmetic unit 302 matches the luminance distribution of the projected image, whereby the light quantity of the light source can be appropriately adjusted and an image with superior contrast can be provided.

When luminance distribution detector 301 is arranged in a stage preceding resolution conversion unit 202, the settings of the starting and ending positions (horizontal/vertical starting coordinate (xs, ys) and ending coordinate (xe, ye)) of data acquisition for finding the luminance distribution of the input video signal must be changed for each switching of the resolution of the input video signal. According to the present exemplary embodiment, luminance distribution detector 301 is provided in a stage that follows resolution conversion unit 202 and these changes therefore need not be carried out.

When OSD display processor 203 is arranged in a stage following luminance distribution detector 301, the luminance distribution of an OSD screen cannot be detected, and when displaying an OSD screen, the function of iris control unit 503 must be turned OFF. According to the present exemplary embodiment, luminance distribution detector 301 is provided in a stage that follows OSD display processor 203, and the luminance distribution of an OSD screen can therefore be detected. As a result, when displaying an OSD screen, the function of the iris control unit 503 need not be turned OFF.

The projector of the present exemplary embodiment described hereinabove is only an example of the present invention, and its configuration and operation are therefore open to modifications as appropriate.

For example, another display element that spatially modulates incident luminous flux such as a digital micromirror device (DMD) may be used in place of LCD 511.

A power control means that controls the power of lamp 501 in accordance with a control signal from CPU 60 may also be used in place of iris control unit 503.

### Second Exemplary Embodiment

FIG. 11 is a block diagram showing the configuration of the projection-type image display device of the second exemplary embodiment of the present invention.

Referring to FIG. 11, the projection-type image display device, which includes light source 1 and display element 2 that displays an image by spatially modulating light from light source 1 based on an input video signal, projects a display image that is displayed in display element 2 on a projection screen. The projection-type image display device further includes trapezoidal distortion correction unit 3, detection unit 4, and adjustment unit 5.

Display element 2 is a display element that spatially modulates incident luminous flux such as an LDC or DMD. Light source 1 is a high-pressure mercury lamp or a solid-state light source of which an LED is representative.

Trapezoidal distortion correction unit 3 carries out pixel conversion that compresses or interpolates pixel data of an input video signals and supplies display element 2 with a corrected signal that includes a first video signal that is a video signal that follows the pixel conversion.

Detection unit 4 detects the luminance distribution of, of the corrected signal that is supplied from trapezoidal distortion correction unit 3, the first video signal. Adjustment unit 5 receives luminance distribution data from detection unit 4 and adjusts the light quantity of light source 1 based on the data that were received.

In the projection-type image display device of the present exemplary embodiment, as in the first exemplary embodiment, the luminance distribution of a video signal that follows trapezoidal distortion correction and that is detected in detection unit 4 matches the luminance distribution of the projected image, whereby the light quantity of light source 1 can be appropriately adjusted and an image of superior contrast can be provided.

In the projection-type image display device of the present exemplary embodiment, an input unit may be provided that receives input operations and supplies as output operation instructions that correspond to the input operations. In this case, trapezoidal distortion correction unit 3 may supply display element 2 with a corrected signal that includes a first video signal and a second video signal that display black images in areas on the display element other than the display area of the image that is based on the first video signal. Detection unit 4 may then be a component that includes: pointer display processor that both supplies display element 2 with a pointer image signal for displaying first to fourth pointers on a projection screen and sets the first to fourth pointers on the projection screen in accordance with operation instructions from the input unit; coordinate set value hold unit that holds each of coordinate values that indicate the display positions of the first to fourth pointers on display element 2 that are set in accordance with operation instructions from the input unit; a luminance distribution detector that detects the luminance distribution of the corrected signal that was supplied as output from trapezoidal distortion correction unit 3; and a luminance distribution arithmetic unit that acquires the luminance distribution of an area indicated by the coordinate values of the first to fourth pointers that are held in the coordinate set value hold unit from the luminance distribution that was detected by the luminance distribution detector.

Adjustment unit 5 may be a component that includes: an iris device in which the size of an aperture is variable, and an iris control unit that controls the size of the aperture according to the luminance distribution that was detected in detection unit 4. Adjustment unit 5 may further be a component that uses a power control means that controls the power of light source 1.

Trapezoidal distortion correction unit 3 and detection unit 4 can apply the configuration of trapezoidal distortion correction unit 204 and detection unit 30 that were described in the first exemplary embodiment.

Alternatively, in place of using pointers to determine the trapezoidal effective pixel area, the trapezoidal distortion of the projected image may be determined based on the information necessary for trapezoidal distortion correction (such as the projection distance, the projection angle with respect to the projection screen, and the power of the projection lens) and the trapezoidal effective pixel area on display element 2 may be determined for correcting this trapezoidal distortion that was determined.

What is claimed is:

1. A projection-type image display device that includes a light source and a display element that displays an image by spatially modulating light from said light source based on an input video signal and that projects a display image that is displayed on the display element onto a projection screen, said projection-type image display device comprising:
a trapezoidal distortion correction unit that carries out pixel conversion, in which pixel data of said input video signal are compressed or interpolated, and that supplies said display element with a corrected signal that contains a first video signal that is a video signal concerning which the pixel conversion has been carried out;
a detection unit that detects a luminance distribution of said first video signal of said corrected signal that is output from said trapezoidal distortion correction unit; and
an adjustment unit that receives said luminance distribution data from said detection unit and adjusts the light quantity of said light source based on the received data.

2. The projection-type image display device as set forth in claim 1, further comprising an input unit that receives input operations and outputs operation instructions according to the input operations; wherein:
said trapezoidal distortion correction unit supplies to said display element said corrected signal that includes said first video signal and a second video signal that displays a black image in areas other than a display area of an image based on said first video signal on said display element; and
said detection unit includes:
a pointer display processor that both supplies to said display element a pointer image signal for displaying first to fourth pointers on said projection screen and sets said first to fourth pointers on said projection screen in accordance with operation instructions from said input unit;
a coordinate set value hold unit that holds each of coordinate values that indicate the display positions on said display element of said first to fourth pointers that are set in accordance with operation instructions from said input unit;
a luminance distribution detector that detects a luminance distribution of said corrected signal that is output from said trapezoidal distortion correction unit; and
a luminance distribution arithmetic unit that acquires a luminance distribution of an area indicated by the coordinate values of said first to fourth pointers that are held in said coordinate set value hold unit from the luminance distribution that is detected by said luminance distribution detector.

3. The projection-type image display device as set forth in claim 1, wherein said adjustment unit includes:
an iris device in which the size of an aperture is variable; and
an iris control unit that controls the size of said aperture according to said luminance distribution that was detected by said detection unit.

4. A light quantity adjustment method that is carried out in a projection-type image display device that includes a light source and a display element that displays an image by spatially modulating light from said light source based on an input video signal and that projects a display image that is displayed on said display element onto a projection screen, said method comprising:
carrying out pixel conversion that compresses or interpolates pixel data of said input video signal and supplying a corrected signal that includes a video signal, concerning which the pixel conversion has been carried out, to said display element; and
detecting a luminance distribution of said video signal, concerning which the pixel conversion has been carried out, of said corrected signal that follows said pixel conversion and adjusting the light quantity of said light source based on the luminance distribution data that was detected.
